(19) United States
(12) Patent Application Publication
(10) Pub. No.: US 2007/0162530 A1
(43) Pub. Date: Jul. 12, 2007

(54) Modular reduction for a cryptographic process and corprocessor for carrying out said reduction

(75) Inventor: Jean-Francois Dhem, Aix en Provence (FR)

Correspondence Address: BUCHANAN, INGERSOLL & ROONEY PC, POST OFFICE BOX 1404, ALEXANDRIA, VA, 22313-1404, US

(73) Assignee: GEMPLUS, Gemenos (FR)

(21) Appl. No.: 10/570,507

(22) PCT Filed: Aug. 23, 2004
(86) PCT No.: PCT/FR04/50390

§ 371 Date: Nov. 30, 2006

(30) Foreign Application Priority Data
Sep. 4, 2003 (FR) 0310445

(51) Int. Cl. G06J 1/00; G06F 7/52; G06F 7/38; G06F 7/50

(52) U.S. Cl. 708/103; 708/7; 708/524; 708/672

(57) ABSTRACT

The invention relates to a cryptographic method wherein, in order to carry out a fully polynomial division of type Q(x)[U(x)/N(x)], wherein Q(x), N(x) and U(x) are polynomials, respectively a result, dividend and a divider, multiplication of the two polynomials is carried out followed by displacement of the bits of the result of the multiplication. The operation is performed on the body of polynomials Fₚ[x]. The invention enables more complex operations to be carried out, including modular operations. The invention is an alternative to the Montgomery method and does not need any correction. It is useful, in particular, for cryptographic methods wherein polynomial operations are carried out on the body F₂[x]. The invention also relates to an appropriate coprocessor for carrying out the method.

The present invention relates to a cryptographic method wherein, a fully polynomial division of type Q(x)=[U(x)/N(x)] is performed, wherein Q(x), N(x) and U(x) are polynomials, respectively a result, dividend and a divider. The invention also relates to an electronic component comprising means for implementing such a method. The invention is in particular applicable for the implementation of cryptographic methods of the public key type on an elliptical curve, for example in chip cards.

Public key algorithms on an elliptical curve allow cryptographic applications of the encoding, digital signature and authentication type. They are widely used in particular in applications of the chip card type, since they allow the use of keys of limited length, permitting fairly short processing times.

In order to perform a modular reduction of the type S=U mod N, the known method initially involves performing a full division of the type Q=[U.N], which aims to calculate the quotient Q defined by the relationship Q*N+S=U and to subsequently determine the remainder of the full division, a remainder that is equal to the result of the modular reduction.

A known method for performing full divisions on whole numbers is the Montgomery algorithm, termed right to left, described in particular in D1 (Menezes, A., Van Oorschot, P., Vanstone, S.: Handbook of Applied Cryptography, CRC Press 1997).

Practice shows however that, in order to perform calculations on elliptical curves, one may work either on integers (in Zp) or on polynomials in Fq(x), q being an integer. In the present invention, we will only deal with the case in which polynomials are processed in Fq(x).

The initial Montgomery method was therefore adapted for performance of modular calculations on polynomials in the body F₂[x]. Refer in particular in this connection to D2 (Koç, c., Acar, T. : Montgomery multiplication in GF(2^{k}), ed.: Designs, Code and Cryptography, Volume 14, Boston 1998, pp 57-69). This adapted algorithm performs in particular a fully polynomial division of U(x) by N(x) noted. Q(x) is defined by the relationship U(x)=Q(x).N(x)+S(x), S(x) being the remainder of the division. The notation [A(x)/B(x)] means the whole part by default of A(x)/B(x).

S(x) is the remainder of the fully polynomial division; it is thus equal to the result of the polynomial modular reduction U(x) mod N(x). The degree of the polynomial N(x) is noted deg(N).α=deg(U)−deg(N) is also defined. In the majority of applications, such as cryptosystems on elliptical curves, N(x) is fixed and constant, at least when one is working on a given elliptical curve.

The adapted Montgomery algorithm is very often used for software implementations of cryptosystems (the whole of an encoding/decoding method and a signature/authentication method on elliptical curves, such as ECDSA, using polynomial representations. Refer in this connection to D3 for example: IEEE Std 1363-2000 standard specifications for public-key cryptography, New York, 2000).

The modular calculation method on polynomials according to Montgomery is certainly effective, but has the disadvantage of introducing an error factor during calculation, known by the name of the Montgomery constant, an error factor which must be corrected at the end of a calculation in order to obtain a correct result. It is observed in practice that the stages necessary for elimination of the error factor are particularly heavy on time and resources (memory space, number of memory accesses, number of operations to be performed, etc.), which may be prohibitive for applications such as chip cards where time and resources are limited.

An initial aim of the invention is to propose, for the implementation of a cryptographic method, an alternative to the Montgomery method which is at least as efficient in terms of use of the resources or calculation time, but without the disadvantages of the Montgomery calculation method. The invention determines the whole part of the quotient of two polynomials and may be used in order to perform more complex operations, including modular operations in the body of the polynomials.

Therefore, according to the invention, in order to perform a fully polynomial division of the type Q(x)=└U(x)/N(x)┘, wherein Q(x), N(x) and U(x) are polynomials, respectively a result, dividend and a divider, multiplication of the two polynomials is carried out followed by displacement of the bits of the result of the multiplication.

The following polynomials are multiplied:

└U(x)/x^{p}┘, corresponding to the dividend displaced by p bits, p being the size of the divider N and

└x^{+β}/N(x)┘, the result of the division of a monomial x^{p+β} by the divider N, β being an integer greater than or equal to α. The result of the multiplication is subsequently displaced by β bits. The following global operation is finally performed:

$$Q ( x ) = ⌊ \frac{⌊ U ( x ) / {x}^{p} ⌋ \times ⌊ {x}^{p + β} / N ( x ) ⌋}{{x}^{β}} ⌋$$

As it will be seen more clearly later, the practical application of such an operation does not require more resources and may be executed just as rapidly as the Montgomery algorithm.

Furthermore, as will also be seen in more detail later, the method according to the invention produces an exact result, does not introduce any error and no error correction is necessary at the end of the procedure; the memory requirements for the data and in terms of ROM for the code are therefore lesser than for the known equivalent methods, particularly the Montgomery algorithm. This is of particular value for applications with a constraint (e.g. chip cards).

The method according to the invention is based in practice on a modular division method on integers, the so-called left to right method described by Barrett in document D4 (Barrett, P: Implementing the Rivest Shamir and Adleman public key encryption algorithm on a standard digital processor, CRYPTO'86, volume 263 of Lecture Notes in Computer Science, Springer Verlag 1987, pp 311-323). The Barrett algorithm is based on the school division method, consisting in zeroing the most significant bits of the numerator and subsequently adding or subtracting a multiple of the denominator. The Barret algorithm is modified according to the invention in order to calculate a quotient in the body F₂[x] of the polynomials (i.e. all the polynomials of which the coefficient of each monomial is an integer of between 0 and p−1).

Q̅ is defined by the following equation:

$$\overline{Q} ( x ) = ⌊ \frac{⌊ U ( x ) / {x}^{p} ⌋ \times ⌊ {x}^{p + β} / N ( x ) ⌋}{{x}^{β}} ⌋ = ⌊ \frac{T ( x ) R ( x )}{{x}^{β}} ⌋ \qquad ( EQ 1 )$$

and it will be shown below that for an appropriate value of β, Q̅(x) is equal to the quotient Q(x) sought, defined by the equation Q(x)=[U(x)/N(x)].

For this purpose, one notes Np(x) in order to indicate that the polynomial N(x) is of size p. One defines furthermore:

$$\frac{U ( x )}{{x}^{p}} = {Φ}_{α} ( x ) + \frac{{Φ}_{p - 1} ( x )}{{x}^{p}}$$

where Φ_{α}(x) and φₚ₋₁(x) are respectively the quotient and the remainder of the division of U(x) by x^{p}. In the same manner, one may write:

$$\frac{{x}^{p + β}}{N ( x )} = Γβ ( x ) + \frac{{λ}_{p - 1} ( x )}{{N}_{p} ( x )}$$

where Γβ(x) and λₚ₋₁(x) are respectively the quotient and the remainder of the division of x^{p+β} by N(x).

One may write:

$$Q ( x ) = ⌊ \frac{( U ( x ) / {x}^{p} ⌋ \times ⌊ {x}^{p + β} / N ( x ) )}{{x}^{β}} ⌋$$

$$Q ( x ) = ⌊ \frac{( {Φ}_{α} ( x ) + \frac{{φ}_{p - 1} ( x )}{{x}^{p}} ) \times ( {Γ}_{β} ( x ) + \frac{{λ}_{p - 1} ( x )}{{N}^{p} ( x )} )}{{x}^{β}} ⌋$$

$$Q ( x ) = ⌊ \frac{\begin{matrix}{Φ}_{α} ( x ) {Γ}_{β} ( x ) + {Φ}_{α} ( x ) \frac{{λ}_{p - 1} ( x )}{{N}_{p} ( x )} + \\ {Φ}_{α} ( x ) + \frac{{φ}_{p - 1} ( x )}{{x}^{p}} + \frac{{φ}_{p - 1} ( x )}{{x}^{p}} \frac{{λ}_{p - 1} ( x )}{{N}_{p} ( x )}\end{matrix}}{{x}^{β}} ⌋$$

three latter terms of the development of Q(x) are null if β≧α. In this case, one has:

$$Q ( x ) = ⌊ \frac{{Φ}_{α} ( x ) {Γ}_{β} ( x )}{{x}^{β}} ⌋$$

$$Q ( x ) = ⌊ \frac{⌊ {Φ}_{α} ( x ) ⌋ \times ⌊ {Γ}_{β} ( x ) ⌋}{{x}^{β}} ⌋$$

$$Q ( x ) = ⌊ \frac{⌊ {Φ}_{α} ( x ) + \frac{{φ}_{p - 1} ( x )}{{x}^{p}} ⌋ \times ⌊ {Γ}_{β} ( x ) + \frac{{λ}_{p - 1} ( x )}{{N}_{p} ( x )} ⌋}{{x}^{β}} ⌋$$

$$Q ( x ) = ⌊ \frac{⌊ U ( x ) / {x}^{p} ⌋ \times ⌊ {x}^{p + β} / N ( x ) ⌋}{{x}^{β}} ⌋ = Q ( \overline{x} )$$

There is no value in choosing β≧α. Furthermore, such a choice requires more calculation than choosing β=α, since R(x) would be longer. In order words, by choosing β=α=deg(U)−deg(N), the quotient Q(x) may be calculated using equation 1:

$$Q ( x ) = ⌊ \frac{⌊ U ( x ) / {x}^{\overline{p}} ⌋ \times ⌊ {x}^{p + β} / N ( x ) ⌋}{{x}^{β}} ⌋ = ⌊ \frac{T ( x ) R ( x )}{{x}^{β}} ⌋ \qquad ( EQ 1 )$$

One should remember that dividing a numerator by x^{β} amounts to displacing the bits of the said numerator by β bits to the right. Furthermore, p, β and N(x) being fixed, one may calculate in an initial phase R(x)=[xp+b/N(x)]. Therefore, according to the method of the invention, calculation of the quotient is reduced to a displacement of p bits, a polynomial multiplication T(x)*R(x) and a shift of β bits.

The method according to the invention, which applies equation 1, is usable on the body F₂[x] of the polynomials, regardless of p.

The method according to the invention may be applied in all polynomials with t-bit architecture, for example 32 bits in which the polynomial modular multiplication is implemented.

The method according to the invention is particularly favourably applied in order to perform polynomial modular reduction in the body F₂[x]. In F₂[x], the coefficients nᵢ of the polynomial number N(x)=nₚ.x^{p}+nₚ₋₁x^{p-1}+ . . . +n₁.x¹+n₀ are either equal to 1 or to 0. This yields a binary representation of the polynomials in F₂[x]: the most significant bits of the representation (=a binary number associated with the polynomial) are the coefficients associated with the highest power monomials of the polynomial. For example, the polynomial x⁵+x³+1 may be represented by the binary number ‘101001’.

Modular multiplication in F₂[x] is one of the most important operations in cryptography on elliptical curves on the Gallois body GF(2P) of size p. It will be shown below that one can obtain using the method according to the invention generally described in the preceding paragraphs similar performances to that which can be obtained using the modular multiplication of Montgomery in GF(2) (refer to D1).

The polynomial modular multiplication A(x)B(x)mod N(x) may be written as a sum of products:

$$Q ( x ) = {\sum }_{i = 0}^{{P}_{A - 1}} {A}_{i} ( x ) \times B ( x ) \times {x}^{it} mod N ( x ) = U ( x ) mod N ( x ) \qquad ( EQ . 2 )$$

with Aᵢ(x) being a polynomial of degree t−1,

$$A ( x ) = {\sum }_{i = 0}^{{P}_{A - 1}} {A}_{i} ( x ) \times {x}^{it} , {P}_{A} = [ {p}_{a} / t ] ,$$

and Pₐ the degree of A(x). The notation [x] means a whole by excess of x.

Before describing the modular reduction in F₂[x] according to the invention, one should be reminded of a few characteristics of the polynomial calculations in F₂[x].
The product of a polynomial of degree t−1 (which may be represented as a binary vector of t bits) by a polynomial of degree n−1 is a polynomial of degree n+t−2 represented as a vector of n+t−1 bits. In comparison, on the integers, the result of the product of a number of t bits by a number of n bits is an integer of n+t bits.
The result of the polynomial addition of two polynomials of degree p is a polynomial of degree p (same number of bits in its binary representation). On the integers, the result of an addition may have an addition bit in its binary representation owing to a possible propagation of carry over.
The “modulo” operation (the remainder of the division of two polynomials) yields a polynomial of a degree strictly smaller than the divider known as the module. This means that the binary vector representing the remainder always has one less bit than the vector representing the module.
On the integers, the remainder is smaller than the module, but may have the same number of bits in its binary representation.

One will now assess how to change the quotient Q(x) of equation 1 (general calculation in F₂[x]) in the case of equation 2 (applied to the calculation in F₂[x]). In order to reduce the memory required and the number of accesses to the memory, equation 2 may be performed by intertwining the multiplication from the highest index of Aᵢ to the lowest with the reduction by N(x). The algorithm 1 below is obtained, which performs a modular multiplication in F₂[x]:

1: U(x)=0

2: For i variant of p_{A}−1 to 0

3: U(x)=U(x).x^{t}/Aᵢ(x)B(x)

4: Q(x)=[U(x)/N(x)]

5: U(x)=U(x)/Q(x)N(x)

(equivalent to U(x)=U(x)modN(x))

6: End for

7: Return Q(x)

Aᵢ is the word of significance i of A, / is the logical function XOR.

It is noted that, in order to perform a modular multiplication according to algorithm 1, only standard multiplications are necessary, in the same manner as in the Montgomery algorithm described in D2.

For the Montgomery method, a polynomial multiplication of t bits (with polynomials of degree t−1) and a division by x^{t} (a displacement of t bits) are necessary (refer to D2). For algorithm 1, a polynomial multiplication of t bits and a division by x^{t-1} are necessary. The remainder of the calculations is the same for the method of the invention and that of Montgomery. Only the order in which the calculations are performed is different: in the invention, one starts from the most significant word A_{pA-1} instead of the least significant word A₀ as in Montgomery.

In algorithm 1, it is possible to reduce the memory access when handling U(x). This is very important since memory accesses constitute a major bottleneck in terms of reduction in execution speed, particularly for chip card applications. For this purpose, the first calculation A_{pA}(x)B(x) has emerged from the loop on i (refer to algorithm 2) in such a way that the loop on i may begin with calculation of the quotient (Q(x)) and the two calculations of U(x) at lines 3 and 5 of algorithm 1 may be grouped together at line 5 of algorithm 2 below (intertwined multiplication in F₂(x)):

1: U(X)=A_{pA-1}(x).B(x)

2: For i variant of p_{A-2} at 0

3: Q(x)=[(T(x).R(x))/x^{t-1}]

4: For j variant of 0 at p_{N-1}

5: U(x)=[U(x)/Q(x)Nⱼ(x)].x^{t.(j+1)}

/ Aᵢ(x)B(j).x^{t.j}

6: End for j

7: End for i

8: Q=[(T(x).R(x))/x^{t-1}]

9: U(x)=U(x)/Q(x).N(x)

These modifications require a final reduction outside loop i (lines 8 and 9 of algorithm 2).

The only disadvantage of intertwining the multiplication and the reduction phase by using a single loop j is that the number of Nⱼ(x) and Bⱼ(x) must be identical (p_{B}=p_{N}), meaning that if, for example, the degree of B(x) is smaller than that of N(x), zeros must be added until it is memorised in the B[j]. However, this does not affect the speed of the practical implementations since B(x) is normally considered of identical size to N(x).

A software implementation of algorithm 2 on processor with t-bit architecture will now be described.

For sake of clarity and ease of comparison with an existing implementation, it will be assumed in the example below that p=p_{A}=p_{N}; in other words that the numbers A and N are p bits.

The detail of the implementation given as an example corresponds to algorithm 4.

In this algorithm 4, (HI, LO) is a virtual register of 2t bits (this type of register is conventional in a RISC architecture performing multiplication of t*t bits with a result on 2t bits) which corresponds to the value resulting from a concatenation of two HI and LO registers, each with t bits. HI and LO are respectively the upper part (the most significant bits) and the lower part (the least significant bits) of the register (HI, LO) of 2t bits. The expression “(HI, LO)>>t” means that the contents of the virtual register (HI, LO) is displaced to the right by t bits. t being the size of the registers, the result is HI=0 and LO=HI.

In algorithm 4, / represents a bit by bit XOR operation and [symbol] represents a polynomial multiplication in F₂[x] on polynomials of a degree of t−1 at most. The operation (HI, LO)/=A [symbol] B is a calculation of multiplication and accumulation of the result in HI, LO (present on the majority of the RISCs or DSP processors) where the internal carryings over in the multiplications and additions are invalidated. An algorithmic representation of this calculation (HI, LO)/=A [symbol] B is showed in algorithm 3 below.

For i variant of 0 to t−1

(HI, LO)=(HI, LO)/((A.((B>>i) AND 1))<<i) End for i

Note: ((B>>i) AND 1) is in practice the i^{th} bit of B

Such a calculation is already implemented as an instruction in some leading processors for chip cards in order to improve the calculations on elliptical curves in GF(2P).

In algorithm 4 also, the notation A[j] represents the polynomial Aj(x) of degree t−1 as described in equation 2 (EQ2).

Finally, Uₛᵤₚ used at lines 10 and 26 of algorithm 4 is generally equal to the current value in LO. This is only true if the most significant bit (MSB) of N[p−1] corresponds to the highest significant degree of N(x). Otherwise, Uₛᵤₚ=(LO<<k)+(Rₛ>>(t−k) where k is the displacement value necessary in order to align the most significant coefficient of N(x) memorised in N[p−1] on the most significant bit of N[p−1].

On algorithm 4, the number of multiplication and accumulation instructions without carryings over is also shown (column # [symbol] ) in addition to the number of accesses to the memory (columns #Load and #Store). In comparison with document D2, we have exactly the same number of multiplications without carryings over, but without additional XOR operations. In order to be correct, the majority of the XOR are included in our multiplication and accumulation operation.

Algorithm 4 of modular multiplication intertwined in F₂[x] is described in detail below.

| | | # [symbol] | #Load | #store |
|---|---|---|---|---|
| 1: | HI = 0 | | | |
| 2: | LO = 0 | | | |
| 3: | Ap−1 = A[p−1] | | 1 | |
| 4: | For j variant of 0 to p−1 | | | |
| 5: | (HI,LO) [symbol] = Ap−1 [symbol] B[j] | p | p | |
| 6: | RS = LO; U[j] = RS | | | p |
| 7: | (HI, LO)>>t | | | |
| 8: | End for j | | | |
| 9: | For I variant of p−2 to 0 | | | |
| 10: | Q = (Usup [symbol] R) >> (t−1) | p−1 | | |
| 11: | Ai = A[i] | | p−1 | |
| 12: | HI = U[0] | | p−1 | |
| 13: | LO = 0 | | | |
| 14: | (HI, LO) [symbol] = Ai [symbol] B[0] | p−1 | p−1 | |
| 15: | U[0] = LO | | | p−1 |
| 16: | (HI, LO) >> t | | | |
| 17: | For j variant of 1 to p−1 | | | |
| 18: | HI = U[j] | | (p−1)² | |
| 19: | (HI, LO) [symbol] = Ai [symbol] B[j] | (p−1)² | (p−1)² | |
| 20: | (HI, LO) [symbol] = Q [symbol] N[j−1] | (p−1)² | (p−1)² | |
| 21: | RS= LO; U[j] = RS | | | (p−1)² |
| 22: | (HI, LO) >> t | | | |
| 23: | End for j | | | |
| 24: | (HI, LO) [symbol] = Q [symbol] N[p−1] | p−1 | p−1 | |
| 25: | End for i | | | |
| 26: | Q = (Usup [symbol] R) >> (t−1) | 1 | | |
| 27: | LO = U[0] | | 1 | |
| 28: | For j variant of 0 to p−2 | | | |
| 29: | HI = U[j+1] | | p−1 | |
| 30: | (HI, LO)/ = Q [symbol] N[j] | p−1 | p−1 | |
| 31: | U[j] = LO | | | p−1 |
| 32: | (HI, LO) >> t | | | |
| 33: | End for j | | | |
| 34: | (HI, LO)/ Q [symbol] N[p−1] | 1 | 1 | |
| 35: | U[p−1] = LO | | | 1 |
| | total | 2p²+p | 3p²+p | p²+p |

The code of algorithm 4 above may be compacted by calculating Aᵢ(x).B(x) intertwined with Q(x).N(x) and in reverse order (refer to algorithm 5), in which j is decremented in algorithm 5, line 11, unlike in algorithm 4, line 17: Aᵢ.B[p−1] and Q(x).N[p−1] is calculated first. This is possible since there is no propagation of carrying over when working on F₂[x], in contrast to that which occurs when working with integers.

B(x) having a degree of less than N(x), the calculations are simplified further by aligning the modulus N(x) on the left when it is memorised in the N[j] (i.e. when one memorises its coefficients N[j] in the directory associated with N), the upper coefficient of N(x) corresponding to the most significant bit (MSB) of N[p−1] (refer to algorithm 5). This requires a single adaptation (final displacement to the right) to the very last result if module N is constant over a set of multiplications. This is particularly the case with the majority of the cryptographic algorithms, such as ECDSA on elliptical curves in GF(2p) (D3).

In the present case, (algorithm 5), Uₛᵤₚ is simply ((HI, LO))/(A[i] [symbol] B[p−1])>>(t−1). Indeed, there is no influence of the term A[i] [symbol] B[p−2] on the desired upper part of U(x), since the term A[i] [symbol] B[p−2] only influences the t−1 first bits of (U[p−1], U[p−2])/A[i] [symbol] B[p−1] and there is no propagation of carrying over. Another favourable consequence of this type of calculation is that there is no longer any need to calculate Aₚ₋₁(x)B(x) in advance and additional final reduction by Q(x)N(x) is no longer required so that lines 1 to 8 and 26 to 35 of algorithm 4 are no longer necessary in algorithm 5.

Algorithm 5 for intertwined modular multiplication is given in detail below, with an internal loop beginning in the opposite order.

| | | # [symbol] | #Load | #store |
|---|---|---|---|---|
| 1: | For j variant of 0 to p−1 | | | |
| 2: | U[j] = 0 | | p | |
| 3: | End for j | | | |
| 4: | For i variant of p−1 to 0 | | | |
| 5: | HI = U[p−1] | | p | |
| 6: | LO = U[p−2] | | p | |
| 7: | Aᵢ = A[i] | p | | |
| 8: | (HI, LO)/ = Aᵢ [symbol] B[p−1] | p | p | |
| 9: | Q = ((HI, LO)ₛᵤₚ [symbol] R)>>(t− | p | | |
| | 1) | | | |
| 10: | (HI, LO)/ = Q [symbol] N[p−1] | p | p | |
| 11: | For j variant of p−2 to 1 | | | |
| 12: | (HI, LO) << t | | | |
| 13: | LO = U[j−1] | | p(p−2) | |
| 14: | (HI, LO)/=Aᵢ [symbol] B[j] | p(p−2) | p(p−2) | |
| 15: | (HI, LO)/=Q [symbol] N[j] | p(p−2) | p(p−2) | |
| 16: | U[j+1] = HI | | | p(p−2) |
| 17: | End for j | | | |
| 18: | (HI, LO) <<t | | | |
| 19: | (HI, LO)/=Aᵢ [symbol] B[0] | p | p | |
| 20: | (HI, LO)/=Q [symbol] N[0] | p | p | |
| 21: | U[1] = HI | | | p |
| 22: | U[0] = LO | | | p |
| 23: | End for i | | | |
| | total | 2p²+p | 3p²+p | p²+p |

As can be seen on algorithm 5, the total number of operations is identical to that of algorithm 4, only the size of the code is slightly smaller and the code may therefore be memorised in a smaller ROM. Except for this last reason, the choice between the two implementations is made by considering the architecture used (CPU or any other specific hardware) with which the calculations are made and the application in which it will be used (for example ECDSA on specific curves).

Algorithm 6 presents the modular multiplication of Montgomery implemented in the same manner as the algorithm of the invention. The main difference in the implementation of the invention in relation to that of Koç and Acar (D2) is the mixture between the multiplication and the reduction phase of the algorithm in order to reduce the number of accesses to the memory. The number of accesses to the memory is much less in the case of the invention in relation to that necessary in the case of the implementation of Koç and Acar. They require (6p²−p) loading and (3p²−2p+1) memorisation operations.

Algorithm 6 of modular multiplication intertwined in F₂[x], according to Montgomery, is given in detail below.

| | | # [symbol] | #Load | #store |
|---|---|---|---|---|
| 1: | For j variant of 0 to p−1 | | | |
| 2: | U[j] = 0 | | | p |
| 3: | End for j | | | |
| 4: | For i variant of 0 to p−1 | | | |
| 5: | Aᵢ = A[i] | | p | |
| 6: | LO = U[0] | | p | |
| 7: | HI = U[1] | | p | |
| 8: | (Rt, LO)/ = Aᵢ [symbol] B[0] | p | p | |
| 9: | (HI, Q) = LO [symbol] N′₀ | p | | |
| 10: | (Rt, LO)/ = Q [symbol] N[0] | p | p | |
| 11 | (HI, LO) >> t | | | |
| 12: | For j variant of 1 to p−2 | | | |
| 13: | HI = U[j+1] | | p(p−2) | |
| 14: | (HI, LO)/=Aᵢ [symbol] B[j] | p(p−2) | p(p−2) | |
| 15: | (HI, LO)/=Q [symbol] N[j] | p(p−2) | p(p−2) | |
| 16: | U[j−1] = LO | | | p(p−2) |
| 17: | (HI, LO) <<t | | | |
| 18: | End for j | | | |
| 19: | (HI, LO) <<t | | | |
| 20: | (HI, LO)/=Aᵢ [symbol] B[p−1] | p | p | |
| 21: | (HI, LO)/=Q [symbol] N[p−1] | p | p | |
| 22: | U[p−2] = LO | | | p |
| 23: | U[p−1] = HI | | | p |
| 24: | End for i | | | |
| | total | 2p²+p | 3p²+p | p²+p |

N′₀ (line 9) is defined by the equation:
N′₀ + N[0]⁽⁻¹⁾ mod x^{t}.

As can be seen on algorithms 4, 5 and 6, the method according to the invention is similar to that of Montgomery in terms of the number of operations of the multiplication and accumulation without carrying over type in addition to the number of memory accesses. The advantage of the method proposed is that it calculates exactly A(x)B(x) modulo N(x), which is not the case with the Montgomery method which calculates A(x)B(x)x^{(-p)} modulo N(x) (D1). The only possible disadvantage of the method according to the invention (this depends on the context) in relation to the Montgomery method may be a slower extraction of Usup from the intermediate values of U(x) and also the displacement to the right of t−1 bits during calculation of Q. This possible software disadvantage may be simply taking into account (at a low cost) in a hardware implementation. This is not the case in order to eliminate the cumbersome x^{(-p)} of the Montgomery multiplication.

Table 1 shows the results, in terms of clock cycles, obtained based on the Montgomery method (algorithm 6) and two version of the method according to the invention (algorithms 4 and 5). This was performed on a modified simulator of the MIPS 32 processor architecture optimised for Montgomery and usable for chip card applications for in order to perform multiplication operations without internal carrying over.

TABLE 1
speed of the algorithms in clock cycles

| | multiplication | multiplication |
|---|---|---|
| | 256 bits | 512 bits |
| algorithm 4 | 910 | 3230 |
| algorithm 5 | 812 | 3028 |
| algorithm 6 | 756 | 2916 |

Table 1 gives an advantage to the Montgomery method. The explanation for this is the software complexity of the evaluation of the quotient at lines 10 and 26 of algorithm 4 and at line 8 of algorithm 5 in relation to line 9 of algorithm 6 (Montgomery), the processor used not having any instructions allowing it to benefit from the new architecture proposed. This does not result in any difference however in a hardware implementation. Furthermore, we should remember that algorithms 4 and 5, according to the invention, have the advantage of yielding an exact result. In contrast, algorithm 6 yields a result to the nearest constant, which must be removed at the end of the algorithm (this is not included in algorithm 6 and must be added).

A second aim of the invention is to propose a processor architecture which is particularly well adapted to the implementation of a method according to the invention as described above and particularly for implementation of the specific operations of algorithms 4 and 5.

An example of an additional block according to the invention is represented in the single FIGURE enclosed. This architecture is to be considered a specific block (coprocessor) which can be grafted on to an existing processor and adapted for performance of elementary calculations (registry loading, addition, multiplication, etc.). The operation of this coprocessor will be described in detail, taking the operations of algorithm 5 as an example. It should be noted that in the FIGURE, only the data paths are represented. For the sake of simplification, the means necessary for control of the various elements of the coprocessor in particular have not been represented.

The coprocessor in the FIGURE grafts on to the data path of an existing processor via an input bus IN_BUS and an output bus “OUT_BUS”.

The coprocessor comprises a calculation circuit “Multiply-Accu”, two multilplexers MUX1 and MUX2 and six registers (HI, LO), U, RBN, A, Q and >>k.

The “Multiply-Accu” block is a purely combinatory block taking 3 values on input (X, Y and Z) on two buses of t-bit size (X and Y) and one bus of 2t-bit size and giving on output the result (on 2t-bit) of the operation (X [symbol] Y [symbol] Z).

The multiplexer MUX1 is a multiplexer with three inputs (0, 1, 2) and one output (all of 2t-bits) ; its output is connected to the input Z of the “Multiply-Accu” circuit. The multiplexer MUX2 comprises three inputs and one output, each of t-bits; its output is connected to the input X of the “Multiply-Accu” circuit. The multiplexers MUX1 and MUX2 are conventional circuits which, as a function of an external command, connect one of their inputs to their output.

The block (HI, LO) is an internal registry of 2t-bits, comprising an input of 2t-bits connected to the output of the “Multiply-Accu” circuit and one output of 2t-bit, the most significant t-bits of which are connected to the input of the OUT_BUS bus. In addition, the 2t-bits of the output of the block (HI, LO) are connected to input 0 of the multiplexer MUX1 and the less significant t bits of the output of the block (HI, LO) are connected to the more significant t bits of input 1 of the multiplexer MUX1.

The block U is an internal registry of t-bits comprising an input of t-bits connected to the IN_BUS bus and an output of t bits connected to the less significant t bits of inputs 1 and 2 of the multiplexer MUX1. The more significant t bits of input 2 of the multiplexer MUX1 are forced to zero. The registry U also comprises an initialisation input RESET. The registry U is used in order to memorise the number U[ . . . ] used in algorithm 5.

The registry RBN of t-bits comprises an input of t-bits connected to the IN_BUS bus and an output of t-bits connected to input Y of the Multiply-Accu circuit. The registry RBN is used in order to memorise the number B[ . . . ] or the number N[ . . . ].

The registry A of t-bits comprises an input of t-bits connected to the IN_BUS bus and an output connected to input 0 of the multiplexer MUX2. The registry A is used to memorise the number A[ . . . ].

The registry Q of t-bits comprises an output of t-bits connected to input 1 of the multiplexer MUX2 and an input of t-bits connected to the significant t-bits t−1 to 2t−2 of the output of the Multiply-Accu circuit (the most significant bit 2t−1 is null and the least significant bits are not significant). The registry Q is used to memorise an intermediate calculation datum.

The registry >>k of t bits comprises an input of 2t-bits connected to the output of the registry (HI, LO) and an output of t-bits connected to input 2 of the multiplexer MUX2. The block >>k is a displacement registry which takes on input a value of 2t-bit, displaces the latter by k-bit to the right (which is tantamount to dividing the input number by 2^{k}) and yields a result of t-bit on output (the t initial bits of the result of the division by 2^{k}).

The memory reading operations (involving U[ . . . ], B[ . . . ], N[ . . . ] and A[ . . . ] load an element of data into the registries U, RBN or A of size t, the data being derived from an external memory (not represented) via an input bus “IN_BUS”. The data resulting from an operation in the coprocessor will be written in the external memory via the “OUT_BUS” bus. The data to be written in the external memory will always be stored in the “Hi” registry (corresponding to the most significant t-bits of the registry (HI, LO).

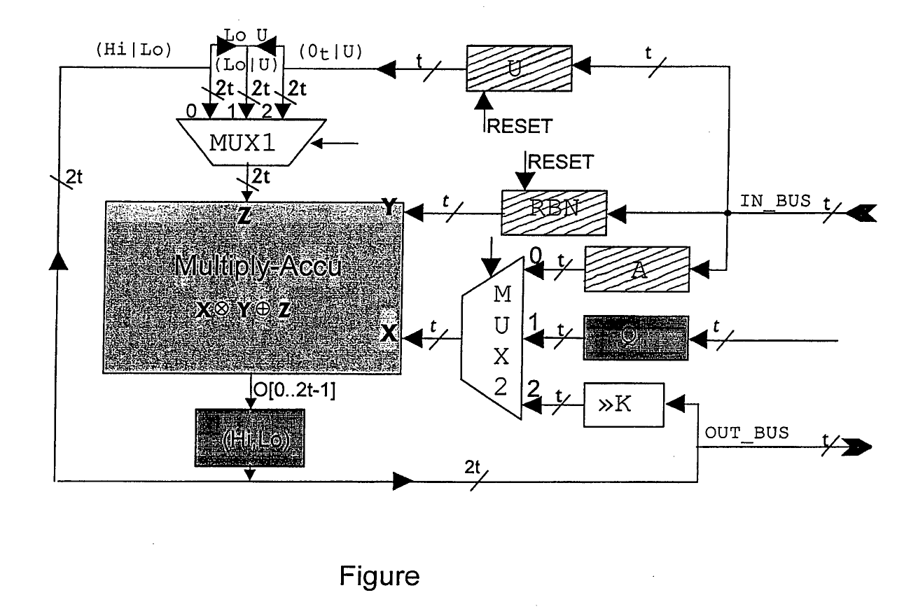

The functioning of the coprocessor will now be described within the context of implementation of algorithm 5. As has been said above, the coprocessor is most often not used for basic operations such as loop operations or initialisation of data in the memory. For example, lines 1, 2, 3, 4, 11, 17 and 23 of FIG. 5 are not processed by the coprocessor, but by the general processor with which it is associated.

Generally speaking, the “master” processor executes the algorithm and selectively calls on the coprocessor (and therefore pilots the coprocessor) in order to perform certain specific operations to be described below. These specific operations might for example be called up by instructions of the coprocessor type in a dedicated architecture or directly integrated in the instructions of the “master” processor.

Operation 1 corresponding to lines 5 and 6 of algorithm 5 is performed in the following manner:

a) the value U[p−1] is transferred from the external memory to the registry U and the registry RBN is zeroed by the RESET command so that the result of the multiplication performed by the multiplier-accumulator is null. The MUX1 is placed in position 2 in such a way that the output of the multiplier-accumulator returns the value of the register U (U[p−1]) which will then be stored in the registry (HI, LO) which thus contains (0, U[p−1]).

b) the value U[p−2] is transferred from the external memory to the registry U and the registry RBN is zeroed by a RESET command so that the result of the multiplication is null. The MUX1 is placed in position 1 in such a way that the output of the multiplier-accumulator returns the value of the registry LO concatenated with that of the registry U (U[p−2]. Finally, (HI, LO) will therefore indeed contain (U[p−1],U[p−2]).

It will be noted that operation 1, which corresponds to operations involving loading of data into the memory, could be performed by the “master” processor; it is however used in parallel here in order to initialise the coprocessor before performance of operation 2 below.

Operation 2 corresponding to line 7 of algorithm 5 simply consists in transferring the value of A[i] from the external memory to the registry A of the present architecture via the “IN_BUS” bus.

Operation 3 corresponding to line 8, 14 or 19 of algorithm 5 is simply performed by:

a) Transfer of B[p−1] (or B[j] and B[0] respectively to lines 14 and 19) from the external memory to the registry RBN.

b) The MUX2 and MUX1 are placed in position 0.

c) The result on output from the multiplier-accumulator is placed in the registry (HI, LO).

Operation 4 corresponding to line 9 of algorithm 5 is performed in the following manner:

a) The value of the constant R, derived from an external memory, is placed in the registry RBN via the external bus “IN_BUS”.

b) The registry U is zeroed (RESET).

c) The displacement registry (>>k) is programmed for a displacement of t−1 (k=t−1) bits.

d) The MUX1 and MUX2 are placed in position 2.

e) The upper part of the result of the calculation on output from the multiplier-accumulator is stored in Q. The choice of the upper part of the result is automatic (and immediate), since the upper output of the multiplier-accumulator corresponding to this result is cabled directly to the input of the registry Q. It is important to note that the registry (HI, LO) must not be updated by this operation.

Operation 5 corresponding to line 10 (or lines 15 or 20 of algorithm 5 is performed in the following manner:

a) N[p−1] (respectively N[j] and N[0] for lines 15 and 20) is transferred to the registry RBN.

b) The MUX1 is placed in position 0 and MUX2 is placed in position 1.

c) The result on output from the multiplier-accumulator is placed in the registry (HI, LO).

Operation 6, corresponding to lines 12 and 13 is performed in the following manner:

a) The value U[j−1] is transferred from the external memory to the registry U.

b) The registry RBN is zeroed (RESET) so that the result of the multiplication is null.

c) The MUX1 is placed in position 1 in such a way that the output from the multiplier-accumulator returns the value (LO, U[j−1]) which will then be stored in the registry in dark grey (HI, LO).

Operation 7 corresponding to lines 16 or 21 is performed in the following manner: HI is transferred to the external memory via the “OUT_BUS” bus to the desired location (U[j+1] and U[1] respectively).

Operation 8 corresponding to line 18 is performed in the following manner (the operation in line 11 is identical, but had been grouped with that of line 12 in order to perform the work more rapidly, the operations being capable of being performed simultaneously):

a) The registries U and RBN are zeroed (RESET).

b) The MUX1 is placed in position 1.

c) The result on output from the multiplier accumulator is stored in (HI, LO).

Operation 9 corresponding to line 22 may be performed by carrying out an operation 8 followed by an operation 7 on U[0] . Both operations may be performed together if necessary in order to improve speed.

Comments:
the “sub-operations” a) . . . d) may (should) generally be performed simultaneously (parallelism) or by using a “pipeline” architecture that gives the impression that they are actually performed in a single operation.
The operations requiring a transfer from an external memory of/to an internal registry may be performed by coprocessor or processor-type operations that adopt as the argument the memory location at which the value processed must be sought or placed (operations 1, 2, 3, 5, 6 and 7).

1. A cryptographic method wherein a fully polynomial division of type Q(x)=[U(x)/N(x)] is performed, where Q(x), U(x) and N(x) are polynomials that respectively constitute a result, dividend and a divider, said method comprising the steps of multiplying two polynomials, displacing the result of the multiplication to provide a second result, and performing at least one of the cryptographic operations of encryption, signing and authentication using said second result.

2. A method according to claim 1, during which multiplication of the following two polynomials is performed:
└U(x)/x^{p}┘, corresponding to the dividend displaced by p bits, p being the size of the divider N
└x^{p+β}/N(x)┘, the result of the division of a monomial x^{p+β} by the divider N, β being an integer greater than or equal to α.

3. A method according to claim 2, in which the result of the multiplication is displaced by β bits.

4. A method according to claim 1, in which the following operation is performed:
$$Q ( x ) = ⌊ \frac{⌊ {U}_{( x ) / X}^{p} ⌋ \times ⌊ {x}^{p + β} / N ( x ) ⌋}{{x}^{β}} ⌋$$

5. A method according to claim 1, in which:
the dividend is obtained by multiplication of two polynomials A(x), B(x),
the polynomials A(x), B(x), the dividend U(x), the divider N(x) and the result S(x) are polynomials defined on F₂[x], a binary number being associated with each polynomial, the value of which and the significance of each bit corresponds to the value and significance of a coefficient of the associated polynomial and
the quotient is calculated according to the following stages:
E1: initialisation of the coefficients of the polynomial U(X)
1: For j variant of 0 to p−1
2: U[j]=0
3: End for j
E2: Decrementing of the variable i of p−1 to 0 and for each value of i, performance of the following stages (a to j):
4: For i variant of p−1 to 0
a: initialisation of the registries HI, LO, Ai
5: Hi=U[p−1]
6: LO=U[p−2]
7: Aᵢ=A[i]
b: multiplication without carrying over of Ai by B[p−1] and accumulation of the result in a virtual registry (HI, LO) comprising the registries HI and LO
8: (HI, LO)/=A₁ [symbol] B[p−1]
c: multiplication without carrying over of (HI, LO)ₛᵤₚ by R and memorisation in the registry Q of the result displaced by t−1 bits to the right
9: Q=((HI, LO)ₛᵤₚ [symbol] R)>>(t−1)
d: multiplication without carrying over of the registry Q by N[p−1] and memorisation in the virtual register (HI, LO)
10: (HI, LO)/=Q [symbol] N[p−1]
e: decrementing of the variable j of p−2 to 0 and for each value of j, performance of the following stages aa to ee:
11: for j variant of p−2 to 1
aa: displacement of t bits to the left in the virtual registry (HI, LO)
12: (HI, LO)<<t
bb: memorisation of the polynomial coefficient U[j−1] in the registry LO
13: LO=U[j−1]
cc: multiplication without carrying over of Ai by B[j] and accumulation of the result in the virtual registry (HI, LO)
14: (HI, LO)/=A [symbol] B[j]
dd: multiplication without carrying over of Q by N[j] and accumulation of the result in the virtual registry (HI, LO)
15: (HI, LO)/=Q [symbol] N[j]
ee: memorisation of the contents of the registry HI in the polynomial coefficient U[j+1]
16: U[j+1]=HI
17: End for j
f: displacement of t bits to the left of the contents of the virtual registry (HI, LO)
18: (HI, LO)<<t
g: multiplication without carrying over of Ai by B[0] and accumulation of the result in the virtual registry (HI, LO)
19: (HI, LO)/=A [symbol] [0]
h: multiplication without carrying over of Q by N[0] and accumulation of the result in the virtual registry (HI, LO)
20: (HI, LO)/=Q [symbol] N[0]
i: memorisation of the registry HI in the polynomial coefficient [1]
21: U[1]=HI
j: memorisation of the register LO in the polynomial coefficient U[0]
22: U[0]=LO
23: End for i

6. A method according to claim 1, in which:
the dividend is obtained by multiplication of two polynomials A(x=, B(x),
the polynomials A(x), B(x), the dividend U(x), the divider N(x) and the result S(x) are polynomials defined on F₂[x], a binary number being associated with each polynomial the value and the significance of each bit of which corresponds to the value and the significance of a coefficient of the associated polynomial and
the quotient is calculated according to the following stages:
E1: initialisation of the registries HI, LO, Aₚ₋₁
1: HI=0
2: LO=0
Aₚ₋₁=A[p−1]
E2: incrementing of the variable j from 0 to p−1 and for each value of j, performance of the following stages (a to c):
4: for J variant from 0 to p−1
a: multiplication without carrying over of Ap−1 by B[j] and memorisation of the result in a virtual registry (HI, LO) comprised of the registries HI and LO
5: (HI,LO) [symbol] =Aₚ₋₁ [symbol] B[j]
b: initialisation of the registry RS and the polynomial coefficient U[j]
6: RS=LO; U[j]=RS
c: displacement of t bits to the right in the registry (HI, LO)
7: (HI, LO)>>t
8: End for j
E3: decrementing of the variable I of p−2 to 0 and for each value of I, performance of the following stages (a1 to g1):
9: for i variant of p−2 to 0
a1: multiplication without carrying over of Usup by R and memorisation of the result displaced by t bits to the right in the virtual registry (HI, LO)
10: Q=(Usup [symbol] R)>>(t−1)
b1: initialisation of the registries Ai, HI, LO
11: Aᵢ=A[i]
12: HI U[0]
13: LO=0
c1: multiplication without carrying over of Ai by B[0] and memorisation of the result in the virtual registry (HI, LO)
14: (HI, LO) [symbol] =Ai [symbol] B[0]
d1: initialisation of the polynomial coefficient U[0]
15: U[0]=LO
e1: displacement of t bits to the right in the registry (HI, LO)
16: (HI, LO)>>t
f1: incrementing of the variable j from 0 to p−1 and for each value of j, performance of the following stages (aa to ee):
17: for j variant from 1 to p−1
aa: initialisation of the registry HI
18: HI=U[j]
bb: multiplication without carrying over of Ai by B[j] and memorisation of the result in the virtual registry (HI, LO)
19: (HI, LO) [symbol] =Ai [symbol] B[j]
cc: multiplication without carrying over of Q by N[j−1] and memorisation of the result in the virtual registry (HI, LO)
20: (HI, LO) [symbol] =Q [symbol] N[j−1]
dd: initialisation of the registry RS and the polynomial coefficient U[j]
21: RS=LO; U[j]=RS
ee: displacement of t bits to the right in the registry (HI, LO)
22: (HI, LO)>>t
23: end for j
g1: multiplication without carrying over of Q by N[p−1] and memorisation of the result in the virtual registry (Hi, LO)
24: (HI, LO) [symbol] =Q [symbol] N[p−1]
25: end for i
E4: multiplication without carrying over of Uₛᵤₚ by R and memorisation of the result in the registry Q of the result displaced by t−1 bits to the right
26: Q=(Usup [symbol] R)>>(t−1)
E5: initialisation of the registry LO
27: LO=U[0]
E6: incrementing of the variable j from 0 to p−2 and for each value of j, performance of the following stages (a2 to d2):
28: for j variant from 0 to p−2
a2: initialisation of the register HI
29: HI=U[j+1]
b2: multiplication without carrying over of Q by N[j] and memorisation of the result in the virtual register (HI, LO)
30: (HI, LO)/=Q [symbol] N[j]
c2: initialisation of the polynomial coefficient U[j]
31: U[j]=LO
d2: displacement by t bits to the right in the registry (HI, LO)
32: (HI, LO)>>t
33: end for j
E7: multiplication without carrying over of Q by N[j] and memorisation of the result in the virtual register (HI, LO)
34: (HI, LO)/=Q [symbol] N[p−1]
E8: memorisation of the coefficient U[p−1] contained in the register LO
35: U[p−1]=LO

7. A cryptographic device including a processor and a coprocessor, said coprocessor comprising:
means for memorising and providing numbers of t bits;
a means for memorising and displacing by k bits a partial result previously obtained, and
a calculation circuit for performing an initial polynomial multiplication of the partial result previously obtained and displaced by a first number of t bits and memorisation of the t significant bits of the result of the first multiplication; wherein said processor performs at least one of the cryptographic operations of encryption, signing and authentication using the result of the calculation performed by said coprocessor.

8. A cryptographic device according to claim 7, in which the calculation circuit also performs a second polynomial multiplication of a second number of t bits by a third number of t-bits in order to produce the partial result previously obtained.

9. A cryptographic device according to claim 7, in which the calculation circuit also performs:
a third polynomial multiplication of the t significant bits of the result of the first multiplication by a fourth number of t-bits and
an addition of the result of the third multiplication and the less significant bits of the result of the first multiplication.

10. An electronic component in order to implement the method according to claim 1.

11. (canceled)

12. A chip card comprising an electronic component according to claim 10.

13. A chip card comprising a cryptographic device according to claim 7.
